(19) United States
(12) Patent Application Publication
(10) Pub. No.: US 2023/0063399 A1
(43) Pub. Date: Mar. 2, 2023

(54) System and Method for Composing Personalized Scratch-Off Lottery Tickets

(71) Applicant: Scientific Games International, Inc., Alpharetta, GA (US)

(72) Inventors: Jeffrey D. Martineck,, SR., Johns Creek, GA (US); Scott B. Garrison, Duluth, GA (US)

(21) Appl. No.: 17/464,004

(22) Filed: Sep. 1, 2021

(51) Int. Cl. A63F 3/06; G07F 17/32; G07F 17/42

(52) U.S. Cl. CPC A63F 3/0665; A63F 3/0655; G07F 17/329; G07F 17/42

(57) ABSTRACT

An instant lottery ticket game system and method includes a set of scratch-off lottery ticket blanks, each lottery ticket blank having a composition area and a separate game play area with play indicia that presents a pre-determined game outcome, the play indicia covered by a scratch-off coating (SOC). The set of lottery ticket blanks are housed within an automated dispenser. An interface is configured with the dispenser and is in communication with the printer, the interface configured to accept player input of personalized indicia for printing in the composition area. A printer is operably configured with the dispenser and is in communication with the interface via a controller. The printer prints the personalized indicia from the player in the composition area to generate a finished scratch-off lottery ticket prior to dispensing of the finished lottery ticket from the dispenser.

### FIELD OF THE INVENTION

The present invention generally relates to a system and method for implementing a scratch-off (“instant”) lottery ticket game, and more particularly to a system and method that provide personalized lottery tickets that can be composed at least in part by purchasers of the lottery tickets.

### BACKGROUND

“Scratch-off” or “instant-win” lottery tickets have enjoyed immense popularity in the lottery industry for decades. These games offer distinct advantages to the lottery authorities and are attractive to a broad spectrum of players. The lottery tickets have a predetermined outcome that is revealed to the player upon removing a scratch-off coating from over game play indicia in a game play area on the ticket. Typically, such lottery tickets are printed with a game theme, such as a sports theme or treasure hunt game theme, that is reflected by the indicia (including images, graphics, and words) in the game play area and the other “real estate” areas on the front face of the ticket, such as the header and instruction areas of the ticket.

The types, formats, and games embodied on the scratch-off lottery tickets must continuously evolve and provide new and exciting gaming experiences to maintain current players and entice new players to the games. It would be beneficial to providers and sponsors of lottery ticket games to generate increased player excitement and enthusiasm by allowing the players to design their own personalized scratch-off lottery tickets without unduly complicating the manufacturing, distribution, and sale of the tickets to the public.

The present invention provides a system and method to address the above-cited need.

### SUMMARY

Objects and advantages of the invention will be set forth in part in the following description, or may be obvious from the description, or may be learned through practice of the invention.

In one embodiment of the invention, an instant lottery ticket game system is provided and includes at least one set of scratch-off lottery ticket blanks, wherein each lottery ticket blank has a game play area with play indicia that presents a pre-determined outcome to the game embodied by the ticket. The play indicia in the game play area is covered by a scratch-off coating (SOC). Each lottery ticket blank also includes a composition area adjacent the game play area. The system includes an automated dispenser, wherein the set of lottery ticket blanks is housed within the dispenser. An interface, such as any combination of an interactive screen, keyboard, touchscreen, and the like, is configured with the dispenser and is in communication with a printer associated with the dispenser. The interface is configured to accept player input of personalized indicia for printing in the composition area. A printer is operably configured with the dispenser (e.g., within or external to the dispenser) and is in communication with the interface, wherein the printer prints the personalized indicia from the player in the composition area to generate a finished scratch-off lottery ticket prior to dispensing the finished lottery ticket from the dispenser.

In a particular embodiment of the game system, the dispenser includes a controller in communication with the interface and the printer, the controller including a plurality of indicia templates that are presentable to the player via the interface. The personalized indicia input by the player may be combined by the controller with the indicia template selected by the player prior to printing the indicia template in the composition area by the printer.

The dispenser controller may be in communication with a central game server, wherein the indicia templates are updated or downloaded to the controller by the central game server.

In another embodiment, the indicia templates may include static indicia associated with a particular event or occasion, wherein the personalized indicia from the player is combined with the static indicia. The indicia is “static” in that it is not changeable by the player input. For example, the static indica may include a “Happy Birthday” message and the player may input personalized indicia to complete or modify the message with a particular name or other unique information or indicia provided by the player.

In yet another embodiment of the system, the dispenser interface and controller are configured to present an empty canvas template to the player that corresponds to the composition area and to accept the player input of personalized indicia for printing in the empty canvas template. For example, the interface and controller may be configured to accept an external image (e.g., a digital picture) presented by the player as the player's personalized indicia. This image may be, for example a digital image in an external storage device presented by the player, wherein the interface includes conventional means for communicating with the external storage device to accept the digital image (e.g., a USB port, Bluetooth connection, etc.).

In still other embodiments, the interface and controller can be configured to present to the player options for backgrounds or borders to be printed in the empty canvas template along with the personalized indicia from the player. These backgrounds and borders may include any manner of design, color scheme, words, etc.

In another unique embodiment of the system, the interface and controller are configured to present to the player an option to purchase the finished lottery ticket with the empty canvas template remaining blank. This option provides the player with the ability to personalize the composition area post-purchase. For example, the player may wish to sketch or paint an image in the composition area, or attach a photograph in the area, and so forth.

In any of the embodiments, the controller may also present a plurality of game play area templates to the player via the interface, wherein the game play area templates present overprint indicia options selectable by the player for printing over the SOC by the printer.

The dispenser may include a plurality of the sets of scratch-off lottery ticket blanks for different games having a different purchase price and prize structure. For example, the dispenser may offer a $1, $5, $10, and $20 ticket, wherein each ticket is associated with a game having a different prize structure (i.e., greater prizes for more expensive tickets).

As with conventional scratch-off lottery tickets, each of the lottery ticket blanks may include a validation code that is linked to an electronic validation file associated with the lottery ticket blank, the validation file containing ticket-specific information for validation and pay-out on the lottery ticket blank.

The invention also encompasses various method embodiments for conducting an instant lottery ticket game, the methods including providing an automated dispenser with a set of scratch-off lottery ticket blanks, wherein each lottery ticket blank has a composition area and a game play area with play indicia that presents a pre-determined game outcome, the play indicia covered by a scratch-off coating (SOC). Via an interface configured with the dispenser and in communication with a printer associated with the dispenser, the method includes accepting input from a player containing personalized indicia for printing in the composition area. The method includes printing the personalized indicia from the player in the composition area to generate a finished scratch-off lottery ticket and then dispensing the finished lottery ticket from the dispenser.

In certain embodiments, the dispenser includes a controller in communication with the interface and the printer, the method presenting a plurality of indicia templates to the player via the controller and interface and accepting via the interface the player input and using the player input to personalize the indicia template. The controller may be in communication with a central game server, wherein the method includes updating or downloading the indicia templates from the central game server.

Other method embodiments may include presenting an empty canvas template to the player via the controller and interface that corresponds to the composition area, and printing the player input of personalized indicia in the empty canvas template. For example, the player input may be an external image presented by the player that is saved in an external storage device presented by the player via the interface.

The method may further include presenting to the player, via the controller and the interface, options for backgrounds or borders to be printed in the empty canvas template along with the personalized indicia from the player.

The method may also include presenting a plurality of game play area templates to the player via the interface, the game play area templates presenting overprint indicia options selectable by the player for printing over the SOC by the printer.

Embodiments of the method may also include providing the dispenser with a plurality of the sets of scratch-off lottery ticket blanks for different games having a different purchase price and prize structure.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 depicts an instant scratch-off lottery ticket blank for use in embodiments of the system and method of the present invention;

FIG. 2 depicts finished scratch-off lottery ticket in accordance with aspects of the present invention;

FIG. 3 is a diagram depicting aspects of making a finished lottery ticket from a lottery ticket blank according to an embodiment of the invention;

FIG. 4 is a block diagram of a system component and method configuration according to embodiments of the invention;

FIG. 5 is a view of a dispenser configured for operation with embodiments of the system and method of the invention; and

FIG. 6 is a block diagram according to a method embodiment of the invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

The term “player” is used herein in a generic sense to encompass a person that composes and purchases the finished lottery ticket or a different person that plays the finished lottery ticket.

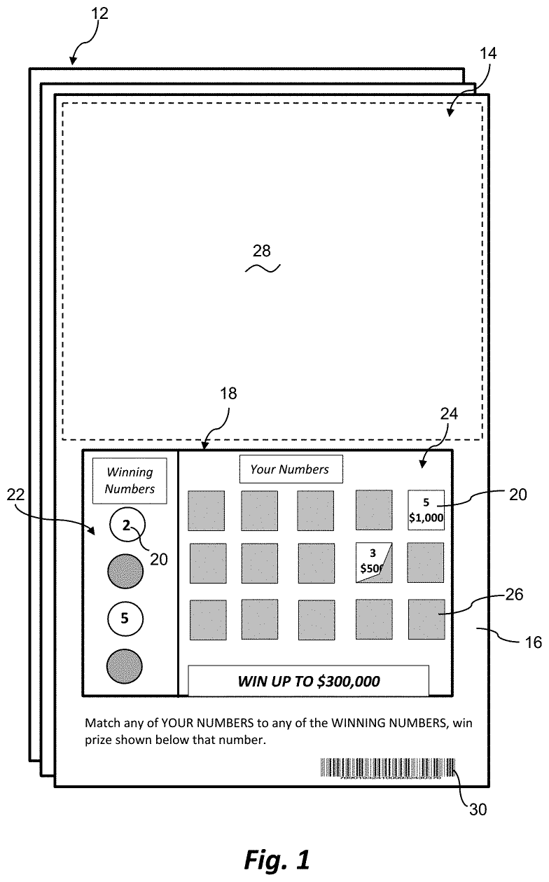

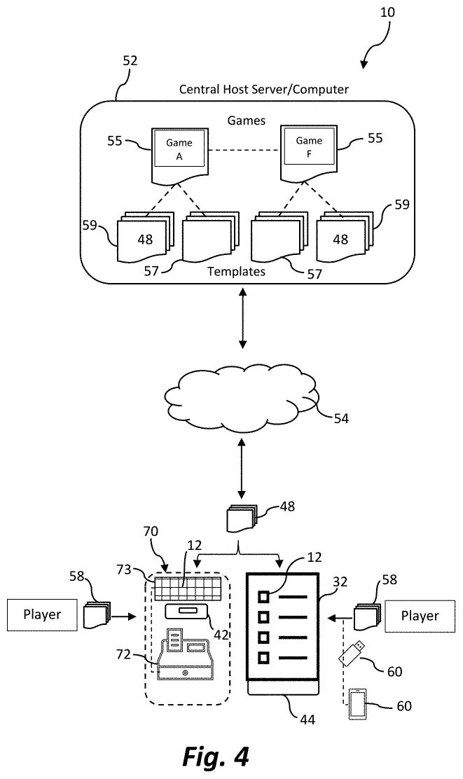

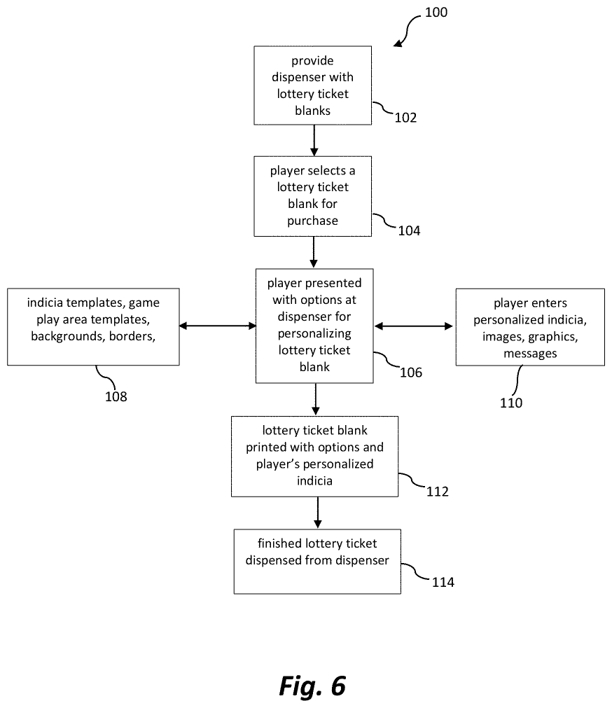

Generally, the present disclosure is directed to an instant lottery ticket game system 10 (FIG. 4) and associated method 100 (FIG. 6) wherein unique scratch-off lottery ticket blanks 14 (FIG. 1) are personalized by a player to compose a finished lottery ticket.

Referring to FIG. 1, an embodiment of a lottery ticket blank 14 is depicted and includes a front face 16 with a game play area 18 having play indicia 20 printed therein that presents to the player a pre-determined outcome of the game embodied by the ticket blank 14. The concept and various forms/styles of scratch-off lottery tickets are well-known to those skilled in the art and a detailed explanation thereof is not necessary for an appreciation or understanding of the present invention. In general, the game play area 18 typically includes a first set 22 of game play indicia 20 covered by a scratch-off coating (SOC) and a separate, second set 24 of game play indicia also covered by the SOC. In a particular style of game, the player scratches off the SOC from both sets 22, 24 and the outcome of the game is determined by the number of matches between the game play indicia 20 in the first set 22 and the game play indicia 20 in the second set 24. Instruction indicia may be provided in the game play area 18 (or any other area of the ticket blank 14) that instructs the player as to how to play the game embodied on the ticket blank 14.

The game outcome is “predetermined” in that the game indicia 20 is preprinted on the ticket blank 14 and the player can take no action to change whether or not the ticket blank 14 is a winning ticket or the prize amount. The lottery ticket blank 14 includes a validation code or number 30 (e.g., a bar code) printed thereon (front or back) that links the ticket blank 14 to an electronic validation file in a remote server/computer system. The validation file includes the status of the ticket (i.e., winning ticket or losing ticket and prize amount) and enables redemption of the ticket blank 14 (in a finished version) by the player.

It should be appreciated that the current system and method embodiments are not limited to any particular type, style, rules, or format of scratch-off game embodied on the lottery ticket blank 14.

Still referring to FIG. 1, each lottery ticket blank 14 includes a composition area 28 also on the front face 16 adjacent to the game play area 18. For example, the composition area 28 may be an upper or header section of the front face 16 adjacent to game play area 18. Conventional scratch-off lottery tickets typically have a game theme (e.g., a sports game theme or a holiday theme) that is presented by graphics, illustrations, indicia, and the like, in the header section of the ticket. In a particular embodiment according to the present disclosure, the lottery ticket blank 14 may be essentially void of a game theme and the composition area 28 may be considered as a blank canvas by which the player can personalize the ticket blank 14 to reflect a special event or occasion, or any other purpose desired by the player, as explained in greater detail below.

Those skilled in the art understand that scratch-off lottery tickets are typically printed with a number of different layers on a paper stock. These layers can include any combination of security layer, game play indicia layer, protective coating layer, primer layer, release layer, SOC layer, overprint layer, and so forth. The lottery ticket blanks 14 may be initially printed in accordance with any suitable combination of layers known and used in the art. The composition area 28 includes a layer or coating that is suitable for overprinting, and may be an exposed primer or base layer that is typically provided in conventional scratch-off lottery ticket constructions to enable printing of the game theme indicia in the header section. Alternatively, the composition area 28 may include a layer of material that is printed or applied for the specific purpose of practicing the present invention.

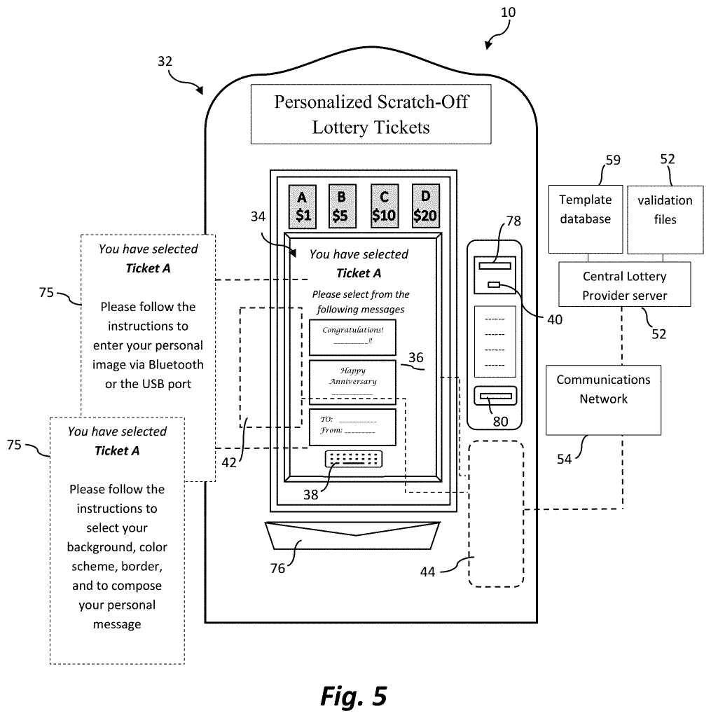

Referring to FIGS. 4 and 5, the system 10 and method 100 include use of an automated dispenser 32 in which sets 12 (e.g., bundles, rolls, or stacks) of the lottery ticket blanks 14 are housed. With reference to FIG. 5, in one embodiment, the dispenser 32 may be a self-serve vending machine type of dispenser that is designed for direct interaction with players and enables the player to make a selection and purchase of lottery tickets directly via the dispenser 32. Examples of such dispensers 32 include the PlayCentral HD, PlayCentral EX and the PlayCentral 54, offered by Scientific Games Corporation having a principal place of business in Alpharetta, Ga., USA, which may be configured with features and functionalities for practice of the present system 10 and method 100.

In an alternative embodiment also depicted in FIG. 4, the automated dispenser 32 may be embodied as a lottery ticket terminal 72 and associated ticket array 73 at a point-of-sale (POS) location 70 of a retail establishment. For example, Scientific Games Corporation offers Flair™ and Wave™ lottery ticket terminals that may be readily configured by those skilled in the art for a system 10 and method 100 as described herein. A patron's request for a scratch-off lottery ticket may be inputted into the lottery ticket terminal 72 by a retail clerk or other employee of the retail establishment by various means. A commercially-available Scientific Games Corporation SciQ™ “smart” lottery ticket dispenser array 73 may be in wired or wireless communication with the terminal 72. This dispenser array includes one or a plurality of individual lottery ticket bins, with each bin typically containing tickets for a different respective lottery ticket game. For example, one bin may contain “Lucky 7” themed scratch-off lottery tickets, while an adjacent bin may contain “Gold Rush” themed scratch-off lottery tickets, and so forth. One or more of the bins may contain sets 12 of the lottery ticket blanks 14 for use with the present system 10 and method 100.

The dispenser 32, whether embodied as a self-serve vending machine as in FIG. 5 or a POS terminal 72 as in FIG. 4, is associated with a printer 42 that is capable of printing indicia, graphics, photos, or any other matter selected by the player for personalizing the lottery ticket blank 14 before a finished ticket is dispensed via the slot 76 in the dispenser 32 (FIG. 5). Conventional commercial printers, such as an ink jet printer, can be readily configured by one skilled in the art for this purpose.

The automated dispenser 32 includes an interface 34 that is configured to accept a player's input of personalized indicia for printing in the composition area 28 by the printer 42. The interface 34 can include any manner of hardware/software configuration. For example, in the embodiment of FIG. 5, the interface 34 may be embodied as an interactive screen 36 that steps the player through the process of selecting options and inputting personalized indicia for printing in the composition area 28. The process may include the use of sequentially displayed windows 75 that step the player through the various options and data input process. The interface may also include a keyboard 38 or touchscreen.

When the dispenser 32 is embodied as terminal 72 configured with a ticket array 73 (FIG. 4), the interface 34 may include a clerk-operated device, such as an interactive screen, keyboard, or other device in communication with the terminal 72 and array 73.

Referring to FIG. 5, the dispenser 32 may include a plurality of the sets of scratch-off lottery ticket blanks 14 for different games (games A-D) having a different purchase price and prize structure. For example, the dispenser may offer a $1, $5, $10, and $20 scratch-off ticket, wherein each lottery ticket blank 14 is associated with a game having a different prize structure (i.e., greater prizes for more expensive tickets).

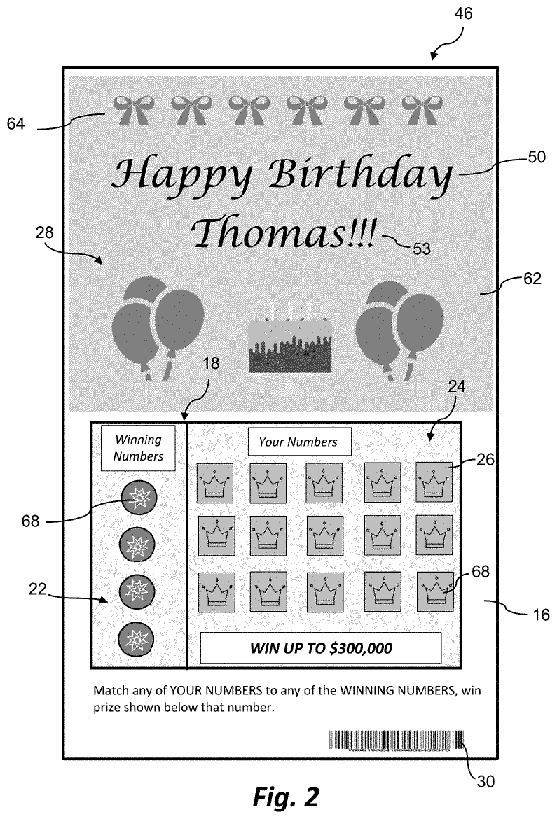

Referring to FIGS. 4 and 5, the dispenser 32 includes a controller 44 that is in communication with the interface 34 and the printer 42. The controller 44 is configured to process various commands and control the hardware components of the dispenser 32 for printing and dispensing a finished lottery ticket 46 (FIG. 2) therefrom. In the POS station 70 embodiment, the controller 44 may be operably associated with the terminal 72.

In a particular embodiment of the system 10 and method 100, the controller 44 has access to or contains a plurality of digital indicia templates 48 to present to the player via the interface 34 (e.g., via the interactive screen 36). The indicia templates 48 may be stored in an internal memory within the controller 44 or in an external storage 59 (FIG. 4) that is accessible by the controller 44 (or downloaded from the storage 59 to the controller 44).

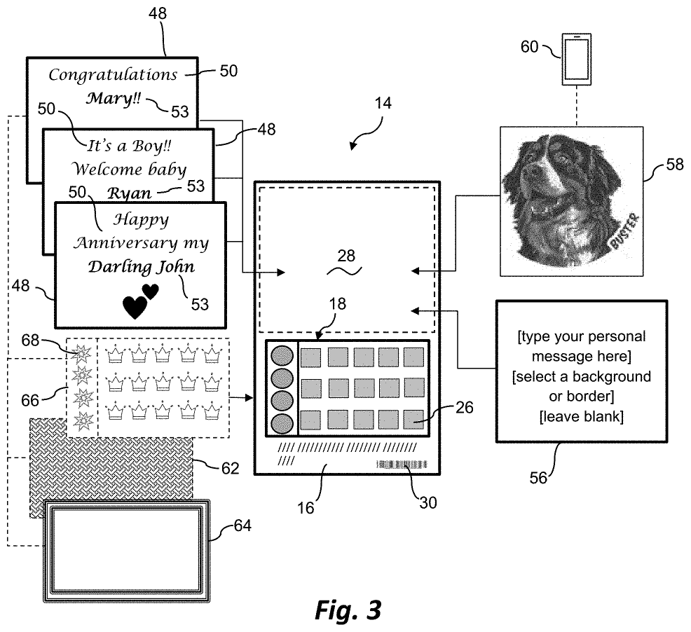

Referring to FIG. 3, the indicia templates 48 may contain any manner of static indicia 50 that can be further modified or combined with personalized indicia 53 that is entered by the player via the interface 34. For example, as depicted in FIG. 3, an indicia template 48 may be provided for various special events, such as a birthday, anniversary, birth announcement, etc. The indicia 50 is “static” in that it is a feature of the template 48 that is not changeable by the player input. The templates 48 may be added to or modified with the personalized player indicia 53, such as by adding a name, date, or other information to the template 48 (as indicated by the highlighted names in the templates 48 of FIG. 3) via the interface 34.

Referring to FIG. 4, the controller 44 associated with the dispenser 32 may be in communication (via a communication network 54) with a central game server 52 that is managed by a game provider. This server 52 may initially store sets of templates 48 for a number of different games (e.g., Game A through F). The templates 48 may be downloaded to the controller 44 on a periodic basis or when a purchase is initiated for an individual ticket at the terminal 72 or dispenser 32. The templates 48 stored remotely at the central server 52 or locally at the controller 44 may also be updated by the central server 52 as needed.

In general, communication between the central host server 52 and controller 44 can be carried via a network interface 54 using any type of wired and/or wireless connection, using a variety of communication protocols (e.g. TCP/IP, HTTP, SMTP, FTP), encodings or formats (e.g. HTML, XML, JSON), and/or protection schemes (e.g. VPN, secure HTTP, SSL). It should be appreciated that the central host server 52 can include a network interface for providing communications over the network 54. A network interface can include any suitable components for interfacing with one more networks, including for example, transmitters, receivers, ports, controllers, antennas, or other suitable components.

The central host server 52 can be any computing device and can include one or more processors and one or more computer-readable media. The computer-readable media can store instructions which cause the processor to perform the operations described herein, as well as other functions related to conduct of the overall game for the lottery authority.

Referring to FIG. 3, embodiments of the system 10 and method 100 may include providing a plurality of game play area templates 66 for the player to select. These templates 66 provide different patterns or styles of overprint indicia 68 that can be printed over the SOC 26 covering the game play indicia 20. These templates 66 may be linked to particular indicia templates 48 such that when the player selects an indicia template 48, one or more linked overprint indicia templates 66 is presented to the player. For example, if the player selects an indicia template 48 related to a birthday, the linked game play area templates 66 may include images of balloons or party hats.

Still referring to FIG. 3, the player may also be presented with options for different backgrounds 62 (e.g., color, patterns, and the like) or borders 64 that can also be printed in the composition area 28 or as part of the overprint indicia 68.

In the embodiments depicted in FIGS. 1 and 3, the composition area 28 is presented to the player via the interface 34 as an essentially blank or empty canvas 56 of a single color or background having little to no other markings or indicia. For example, the composition area 28 may be presented as a clean, empty white space. As particularly depicted in FIG. 3, the player is presented with options to create a specialized theme with a personalized message using the indicia templates 48, background options 64, borders 62, and game play area templates 66.

FIG. 3 also depicts an embodiment wherein the player has the option to import an external image 58, such as a photograph or other digital image, from an external storage device 60 (e.g., a mobile phone or flash drive) for printing in the blank composition area 28. The image may be combined with any one or more of the templates 48, 66, background options 64, borders 62, and so forth. The dispenser 32 (particularly the interface 34 and controller 44) is configured to communicate with the external storage device 60 to accept the external image 58. For example, the dispenser may be configured with a USB port to accept an external flash drive presented by the player. Alternatively, the dispenser may be configured for a wireless exchange of the external image 58 from the player's storage device 60 (e.g., via Bluetooth).

Referring again to FIG. 3, the player may also be presented with the option to purchase the lottery ticket blank 14 without adding indicia of any type to the composition area 28. The template 56 associated with the blank composition area 28 may provide such option. This option may be desirable to many players in that they are free to compose virtually any manner of highly personalized art, design, message, and so forth, in the blank composition area 28 at a later time using any means they desire, such as paint, ink, stick-on materials, and so forth.

FIG. 2 depicts an embodiment of a finished lottery ticket 46 made with the system 10 and method 100 of the present invention. The composition area 28 has been printed with the player's inputted personalized indicia 53 used to modify one of the indicia templates 48. The finished ticket 46 is also printed with the player's selection of a border 64, background 62, and game play area template 66 with overprint indicia 68.

The present invention also encompasses various method embodiments for conducting an instant lottery game with personalized scratch-off lottery tickets. FIG. 6 depicts an embodiment of such a method 100, aspects of which are discussed above.

At step 102, an automated dispenser (vending-machine type or POS terminal based) is supplied with one or more sets of lottery ticket blanks described above.

Step 104 indicates that the player makes a selection of one of the lottery ticket blanks for purchase.

At step 106, via the interface configured with the dispenser, the player is presented with options for personalizing the lottery ticket blank. Step 108 indicates that the options may be presented by way of indicia templates, game play area templates, background and border selections, and so forth. Step 110 indicates that, via the interface, the player enters personalized indicia, such as (but not limited to) images, graphics, messages, and so forth, as discussed above.

At step 112, via a printer configured with the dispenser, the lottery ticket blanks are printed with the player's selected options and personalized indicia to generate a finished lottery ticket.

At step 114, the finished lottery ticket is dispensed from the dispenser.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. An instant lottery ticket game system, comprising:
a set of scratch-off lottery ticket blanks, each lottery ticket blank comprising a game play area with play indicia that presents a pre-determined game outcome, the play indicia covered by a scratch-off coating (SOC);
each lottery ticket blank further comprising a composition area adjacent the game play area;
an automated dispenser, the set of lottery ticket blanks housed within the dispenser;
an interface configured with the dispenser and in communication with a printer associated with the dispenser;
the interface configured to accept player input of personalized indicia for printing in the composition area; and
wherein the printer prints the personalized indicia from the player in the composition area to generate a finished scratch-off lottery ticket prior to dispensing the finished lottery ticket.

2. The instant lottery ticket game system as in claim 1, wherein the dispenser comprises a controller in communication with the interface and the printer, the controller configured to present a plurality of digital indicia templates to the player via the interface, wherein the personalized indicia input by the player is combined by the controller with the indicia template selected by the player prior to printing the indicia template in the composition area by the printer.

3. The instant lottery ticket game system as in claim 2, wherein the controller is in communication with a central game server, the indicia templates updated or downloaded to the controller by the central game server.

4. The instant lottery ticket game system as in claim 2, wherein the indicia templates comprise static indicia associated with a particular event or occasion, wherein the player input personalizes the static indicia

5. The instant lottery ticket game system as in claim 1, wherein the dispenser comprises a controller in communication with the interface and the printer, the interface and controller configured to present an empty canvas template to the player corresponding to the composition area and to accept the player input of personalized indicia for printing in the empty canvas template.

6. The instant lottery ticket game system as in claim 5, wherein the interface and controller are configured to accept an external image presented by the player as the player personalized indicia.

7. The instant lottery ticket game system as in claim 6, wherein the external image is a digital image in an external storage device presented by the player, the interface comprising means for communicating with the external storage device to accept the digital image.

8. The instant lottery ticket game system as in claim 5, wherein the interface and controller are configured to present to the player options for backgrounds or borders to be printed in the empty canvas template along with the personalized indicia from the player.

9. The instant lottery ticket game system as in claim 5, wherein the interface and controller are configured to present to the player an option to purchase the finished lottery ticket with the empty canvas template remaining blank.

10. The instant lottery ticket game system as in claim 1, wherein the dispenser comprises a controller in communication with the interface and the printer, the controller presenting a plurality of game play area templates to the player via the interface, the game play area templates presenting overprint indicia options selectable by the player for printing over the SOC by the printer.

11. The instant lottery ticket game system as in claim 1, comprising a plurality of the sets of scratch-off lottery ticket blanks for different games having a different purchase price and prize structure.

12. The instant lottery ticket game system as in claim 1, wherein each lottery ticket blank comprises a validation code that is linked to an electronic validation file associated with the lottery ticket blank, the validation file containing ticket-specific information for validation and pay-out on the lottery ticket blank.

13. A method for conducting an instant lottery ticket game, comprising:
providing an automated dispenser with a set of scratch-off lottery ticket blanks, each lottery ticket blank having a game play area with play indicia that presents a pre-determined game outcome, the play indicia covered by a scratch-off coating (SOC), each lottery ticket blank further comprising a composition area;
via an interface configured with the dispenser and in communication with a printer associated with the dispenser, accepting input from a player containing personalized indicia for printing in the composition area;
printing the personalized indicia from the player in the composition area to generate a finished scratch-off lottery ticket; and
dispensing the finished lottery ticket from the dispenser.

14. The method as in claim 14, wherein the dispenser includes a controller in communication with the interface and the printer, the method further comprising presenting a plurality of indicia templates to the player via the controller and interface and accepting via the interface the player input and using the player input to personalize the indicia template.

15. The method as in claim 14, wherein the controller is in communication with a central game server, the method comprising updating or downloading the indicia templates from the central game server.

16. The method as in claim 14, wherein the dispenser includes a controller in communication with the interface and the printer, the method further comprising presenting an empty canvas template to the player via the controller and interface that corresponds to the composition area, and printing the player input of personalized indicia in the empty canvas template.

17. The method as in claim 16, comprising accepting via the interface an external image presented by the player as the player input of personalized indicia, wherein the external image is a digital image in an external storage device presented by the player.

18. The method as in claim 16, further comprising presenting to the player via the controller and the interface options for backgrounds or borders to be printed in the empty canvas template along with the personalized indicia from the player.

19. The method as in claim 14, wherein the dispenser includes a controller in communication with the interface and the printer, the method further comprising presenting a plurality of game play area templates to the player via the interface, the game play area templates presenting overprint indicia options selectable by the player for printing over the SOC by the printer.

20. The method as in claim 14, further comprising providing the dispenser with a plurality of the sets of scratch-off lottery ticket blanks for different games having a different purchase price and prize structure.
